(19) United States
(12) Patent Application Publication
(10) Pub. No.: US 2005/0050791 A1
(43) Pub. Date: Mar. 10, 2005

(54) All-in-one fishing gear box

(76) Inventor: Steven R. Placek, Altoona, WI (US)

Correspondence Address: Law Offices of John D. Gugliotta, PE, Esq., 202 Delaware Building, 137 South Main Street, Akron, OH, 44308, US

(21) Appl. No.: 10/920,565

(22) Filed: Aug. 18, 2004

Related U.S. Application Data
(60) Provisional application No. 60/495,842, filed on Aug. 18, 2003.

(51) Int. Cl. A01K 97/06; A01K 97/08

(52) U.S. Cl. 43/54.1

(57) ABSTRACT

A tackle box for fishing gear and accessories comprises a container having a recessed storage area and a drawer, each for storage of fishing accessories. The drawer is subjacent the storage area. The storage area is divisible by dividers that may be added or removed as desired. The storage area is defined by the walls of the container, the walls having a plurality of channels for seating, securing and holding fishing rods placed therein for transportation.

### RELATED APPLICATIONS

This application claims the benefit of U.S. Provisional Application No. 60/495,842 filed on Aug. 18, 2003.

### BACKGROUND OF THE INVENTION

1. Field of the Invention

The present invention relates generally to a fishing tackle box and, more particularly, to a tackle box with a plurality of compartments to organize and transport a substantial volume of fishing gear including a fishing rod.

2. Description of the Related Art

A great number of people around the world enjoy fishing. Whether fishing for food or for the sport of it, the sport a popular recreational pastime. While the exposure to the outdoors and associated relaxation benefits associated with such a sport are enjoyable, the work associated with transporting fishing equipment is not. Many people desire to carry multiple fishing rods and tackle boxes from their home, to a car, to a hotel, to a boat or fishing location, and then back again. Additionally, when these items are transported, several trips may be necessary to accommodate all of the equipment. Accordingly, there exists a need for a means by which fishing equipment can be organized, stored and transported with reasonable ease. The creation and development of the present invention fulfills this need.

A search of the prior art did not disclose any patents that read directly on the claims of the instant invention; however, the following references were considered related:

U.S. Pat. No. 5,163,694, issued in the name of Reichek, discloses a buoyant fishing tackle support having a body member with many compartments, the body member accommodating mounting of a box;

U.S. Pat. No. 5,402,596, issued in the name of Gillming, Jr., discloses a floating holder for a wading fisherman's accessories comprising a floating platform and a plurality of fishing rod supports;

U.S. Pat. No. 5,864,981, issued in the name of Zeman, discloses a combination tackle box, bait well and cooler;

U.S. Pat. No. 5,941,015, issued in the name of Jenkins, discloses a multiple featured fishing system comprising a housing having a tackle box, a securing means, fishing rod holders and a tool box;

U.S. Pat. No. 6,325,395, issued in the name of Frymoyer, discloses a wheeled buoyant decoy transporting device;

U.S. Pat. No. 6,446,382, issued in the name of Cloutier et al., discloses a combined fishing tackle holder and food cooler consisting of a cabinet component atop each of four corner legs, the cabinet having a wholly insulated hollow center;

U.S. Pat. No. 6,487,814, issued in the name of Arredondo et al., discloses a fishing accessories storage apparatus comprising a support member having a base and a wall member with first and second sides, and having first and second cabinet members; and

U.S. Pat. No. D456,974, issued in the name of Hicks, discloses an ornamental design for a fishing rod holder and caddy.

Consequently, there exists a continuous need for new ideas and enhancements for existing products in the fishing accessory industry.

### SUMMARY OF THE INVENTION

It is therefore an object of the present invention to provide an improved tackle box for fishing gear and accessories.

It is a feature of the present invention to provide a tackle box having a recessed storage area and a slidable drawer for storage of fishing accessories.

It is a feature of the present invention to provide a tackle box having a plurality of channels formed in the walls of the container, and within the recessed storage area. The channels are formed in opposing walls, and channels in one wall are linearly aligned with channels in the opposing wall for seating, securing and holding fishing rods for transportation.

It is another feature of the present invention to provide a tackle box having a removable cover for enclosing and protecting the contents of the recessed storage area.

It is another feature of the present invention to provide a tackle box having an adjustable handle for finding the proper weight distribution of the box in relation to the contents possessed thereby.

Briefly described according to one embodiment of the present invention, a tackle box for fishing gear and accessories comprises a container having a recessed storage area and a drawer, each for storage of fishing accessories. The drawer is subjacent the storage area. The storage area is divisible by dividers that may be added or removed as desired. The storage area is defined by the walls of the container, the walls having a plurality of channels for seating, securing and holding fishing rods placed therein for transportation.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of a tackle box for fishing gear and accessories having a recessed storage area and a drawer;

FIG. 2 is a perspective view of the tackle box with the drawer closed and fishing rods seated in the channels provided in the walls of the container;

FIG. 3 is a side view of the tackle box illustrating the channels and optional U or V-shaped inserts or components;

FIG. 4 is a perspective view of the container with an option cover attached;

FIG. 5 is a perspective view of the cover having a bar and a handle; and

FIG. 6 is a side view of the box with attachable storage containers coupled thereto.

### DESCRIPTION OF THE PREFERRED EMBODIMENTS

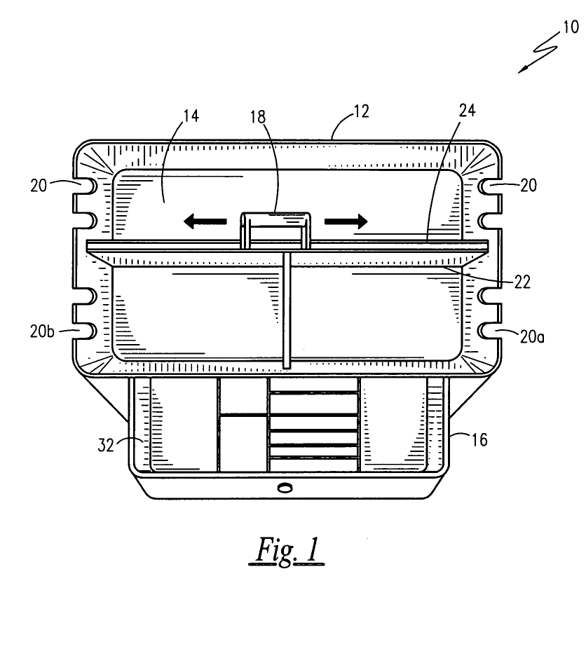

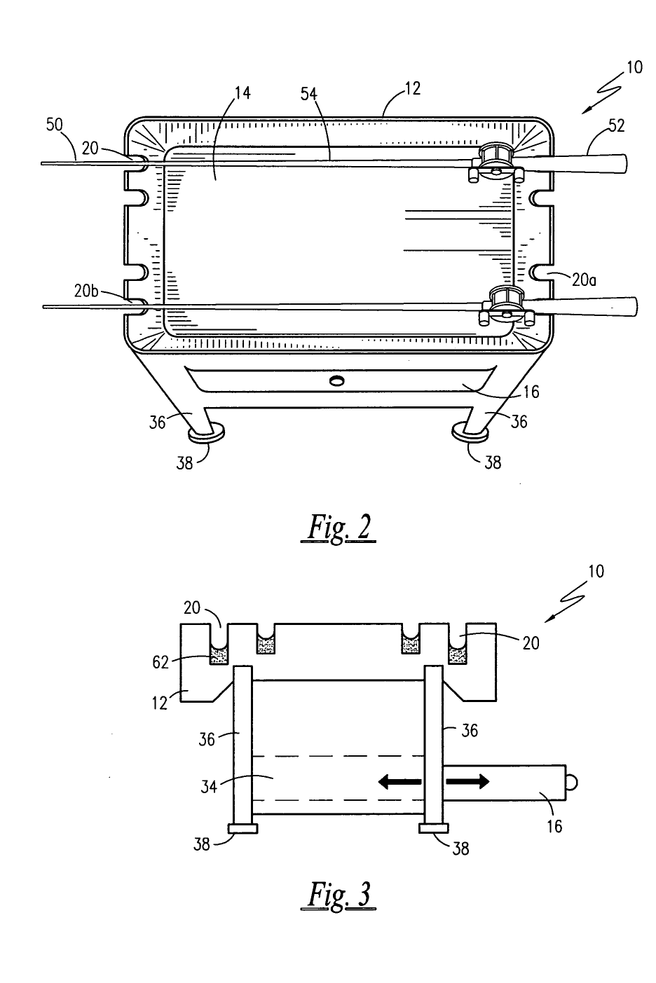

The best mode for carrying out the invention is presented in terms of its preferred embodiment, herein depicted within FIGS. 1 through 6.

1. Detailed Description of the Figures

Referring to FIG. 1 through FIG. 3, a tackle box 10 is shown in accordance to a preferred embodiment of the present invention. The tackle box 10 comprises a container 12 having a recessed storage area 14 and a drawer 16. The box 10 has a handle 18 adjustable along the length of the storage area 14. The storage area 14 also has a plurality of channels 20 for receiving and holding fishing rods 50.

The container 12 is envisioned as having an upper storage area and a lower storage area for organizing fishing accessories and other supplies. The upper storage area is the recessed storage area 14 is defined by the upstanding wall or walls of the container 12 (number of walls dependent upon the geometric configuration of the container 12). The storage area 14 may be segregated into smaller compartments by a plurality of dividers 22 placed within the wall(s) of the container 12. A plurality of channels 20 are formed in the wall(s) of the container 12 for securely receiving and holding fishing rods 50 for pedestrian transportation. As depicted and envisioned, the channels 20 are formed along two opposing walls (for an orthogonally shaped container 12, as depicted), with channels 20 along one wall linearly aligned with channels 20 along the opposing wall, thus allowing a fishing rod 50 to be placed so that the fishing rod handle 52 is seated in a channel 20a and the shaft of the rod 54 is seated in a channel 20b, for example. To aid in seating of a rod 50, the channels 20 may include a V or U-shaped insert or component 62 that accommodates the shape and dimension of the rod handle or the shaft, creating friction fit or interference impingement of the rod within the channels 20.

The box 10 has a handle 18 that is lockable into a specific position along the linear length of the container 12 and/or storage area 14. The handle 18 is adjustable about a linearly elongated bar 24. The bar 24 is envisioned as disposed between the walls of the container 12 or as disposed within a cover 26 that is removably secured to the container 12, a further discussion of the cover 26 provided below. The user may adjust the handle 18 about the container 12 or cover 26 to achieve the appropriate balance and weight distribution for pedestrian transportation. In one envisioned embodiment, the handle 18 locks into a specific position along the bar 24 upon lifting of the handle 18, and then unlocking or releasing upon release of the handle 18.

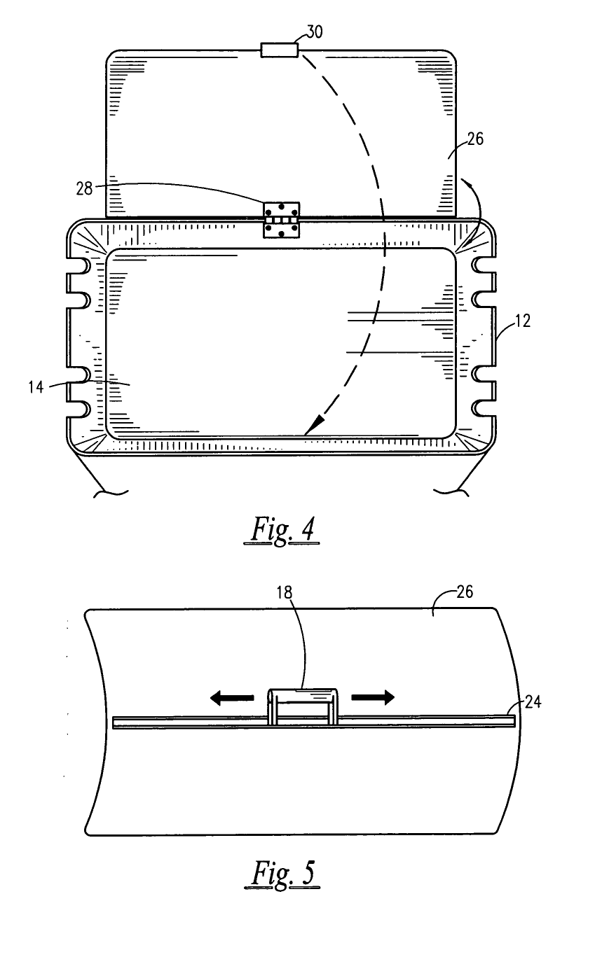

Referring now to FIG. 4 and FIG. 5, the cover 26 is mountable to the container 12 via at least one hinge 28, although more than hinge is also envisioned. The cover 26 envelopes and substantially conceals the contents of the storage area 14, including the items stored in the storage area 14 and the fishing rods 50 placed in channels 20. The cover 26 has at least one latch 30, although more than one latch is also envisioned, the latch 30 permitting securement of the cover 26 to the container 12 as a whole.

The lower storage area of the container 12 is envisioned as a drawer 16 that is selectively slidable for accessing the contents therein. The drawer 16 has a plurality of compartments 32 of varying dimension to accommodate the multitude of varying fishing accessories presently available and popular. The drawer 16 is housed in a space or cavity 34 defined by the container 12, the space or cavity 34 subjacent the storage area 14. The space or cavity 34 inhibits the disorganization or loss of accessories stored therein, as the space or cavity 34 is dimensioned to be no larger than necessary to accommodate the dimension of the drawer 16.

The container 12 further includes legs 36, wherein each leg 36 is adjustable and has a universal footing 38, permitting the box 10 to rest on flat and uneven surface structures.

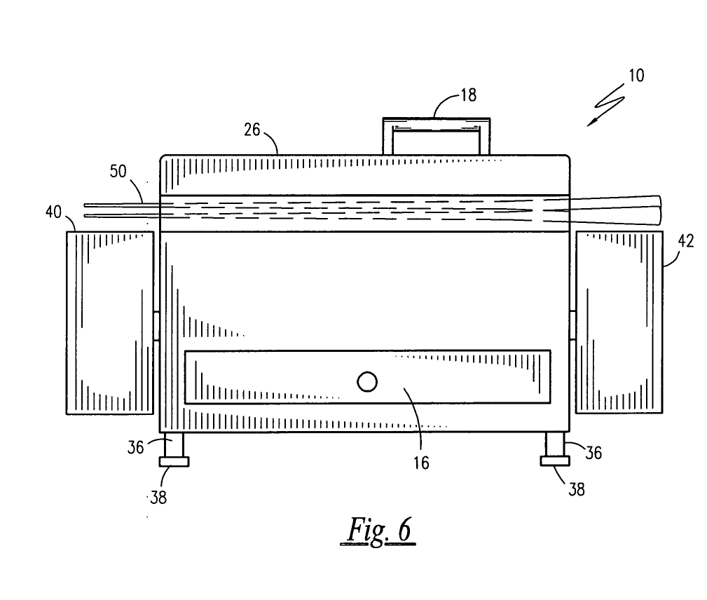

It is envisioned that the box 10 may include other attachable and detachable accessories, including additional storage containers 40 and 42, for example, and as depicted in FIG. 6, of comparatively smaller dimensions than the container 12, attachable and detachable along the sides or ends of the box 10. The containers 40 and 42 are envisioned as suitable for use in storing bait (live or dead), for use as a cooler in storing beverages, ice or spoilable food, or other common uses, such as for disposing garbage, among other uses.

The box 10 is a fishing tackle box with integral support legs, rod and reel holding system, minnow, cooler and bait containers, and other enhanced features particular to the common needs of fishing. The box 10 resembles a conventional tackle box with overall dimensions of approximately 18 inches by 13½ inches, however, it is evident that the invention embodies substantial improvements compared to the existing art. First, the invention utilizes unique, adjustable support legs with a plurality of universal footings that permits use on both flat and uneven surfaces. Second, a large sliding storage tray, or trays, provides ample organization and storage for fishing lures and accessories. Third, multiple storage compartments not only provide storage for more fishing accessories, but can also be utilized for food, personal hygiene, flashlight, emergency aid and other items that could be required. Fourth, large comfortable, slide-locking handles provide for even weight distribution and ease of transport. Fifth, fishing rod slots and associated securing devices can accommodate several fishing rods and reels, without having to carry them separately. Finally, a separate minnow bucket, cooler and bait components provide onboard storage which eliminates transporting separate containers. The sealed construction system of the invention allows it to float in water thus ensuring a high probability of recovery from accidental loss. The use of the All-In-One Fishing Gear Box provides a means for anyone to organize, store and transport a large amount and variety of fishing gear virtually anywhere in a manner which is quick, easy and efficient. Although the preceding teaches a preferred embodiment of the invention as required, additional configurations for commonly used fishing gear and accessories are anticipated to include, but limited to: backpack frame, universal mounting for compartments, removable hinged cover with onboard storage when removed, separable main components, specialized uses for footings, and other uses and configurations can accommodate.

It is envisioned that other styles and configurations of the present invention can be easily incorporated into the teachings of the present invention, and only one particular configuration shall be shown and described for purposes of clarity and disclosure and not by way of limitation of scope.

2. Operation of the Preferred Embodiment

To use the present invention, a user will arrange the dividers 22 within the recessed storage area 14 to accommodate the items that the user wishes to easily and/or immediately access without having to plunder through a drawer. For transporting one or more fishing rods 50, the user will align a single rod 50 between corresponding, and linearly aligned, channels 20 (such as 20a and 20b in the figures) and seat the reel end and the shaft so that the rod 50 is securely held and supported by the channels. This may be repeated for multiple rods 50. The optional cover 26 may be secured thereafter, first by coupling the hinge(s) 28 to one side of the container 12 and then coupling the latch(es) 30 to the opposing side of the container 12, thereby enclosing and protecting the contents of the storage area 14. The user will ensure that all the necessary accessories for storage in the drawer 16 are placed therein, and the drawer 16 returned to a stowed position within the space or cavity of the container 12 subjacent the storage area 14. Thereafter, the user may adjust the handle 16 along the corresponding bar until proper weight distribution is achieved, and then proceed to transport the fishing gear to a particular destination.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents. Therefore, the scope of the invention is to be limited only by the following claims.

1. A tackle box comprising:
a container having a recessed storage area and a drawer;
a handle adjustable along the length of said storage area;
a plurality of channels formed in walls of said container, said channels linearly aligned for receiving and holding at least one fishing rod.

2. The tackle box of claim 1 further comprising a plurality of dividers for forming segregated compartments in said recessed storage area.

3. The tackle box of claim 1, wherein said handle is adjustable along a linearly elongated bar disposed between said walls of said container.

4. The tackle box of claim 1 further comprising a cover attachable to said container.

5. The tackle box of claim 4, wherein said cover comprises:
at least one hinge for securing said cover to said container in a pivoting manner; and
at least one latch for securing said cover to said container so as to enclose the contents of said recessed storage area.

6. The tackle box of claim 4, wherein said cover has a linearly elongated bar for receiving and adjusting of said handle.

7. The tackle box of claim 1 further comprising legs depending from said container, wherein each one of said legs is adjustable and has a universal footing.

8. The tackle box of claim 1 further comprising a storage container attachable to said container.

9. The tackle box of claim 1 further comprising a plurality of storage containers attachable to said container.

10. The tackle box of claim 1 further comprising U or V-shaped components positioned in said channels for accommodating the shape of the rod.
